(19) United States
(12) Patent Application Publication
(10) Pub. No.: US 2024/0425223 A1
(43) Pub. Date: Dec. 26, 2024

(54) OIL DRAIN PAN

(71) Applicant: HOPKINS MANUFACTURING CORPORATION, Cleveland, OH (US)

(72) Inventor: Kyle M. Bennett, Emporia, KS (US)

(73) Assignee: HOPKINS MANUFACTURING CORPORATION, Cleveland, OH (US)

(21) Appl. No.: 18/745,887

(22) Filed: Jun. 17, 2024

Related U.S. Application Data
(60) Provisional application No. 63/508,377, filed on Jun. 15, 2023.

(51) Int. Cl. B65D 1/34; B65D 25/10; B65D 25/42

(52) U.S. Cl. CPC B65D 1/34; B65D 25/108; B65D 25/42

(57) ABSTRACT

An oil drain pan with an improved pour spout that allows for proper transfer of liquid from the drain pan into other containers. The provided oil drain pan further provides an improved oil filter holder that allows complete drainage of oil from an oil filter with reduced or eliminated spillage and with reduced or eliminated manual intervention to allow complete drainage of the filter.

### TECHNICAL FIELD

The present disclosure related generally to automotive tools and accessories. More particularly, in one example, the present disclosure relates to vehicle oil drain pans for use in draining engine oil. Specifically, in another example, the present disclosure relates to a high-capacity vehicle oil drain pan with a spout and oil filter holder.

### BACKGROUND ART

Vehicle oil drain pans are tools used in draining and disposing of engine oil from a vehicle or other similar oil lubricated devices. For example, when performing routine maintenance on an automobile engine including an oil change, the oil is drained from the vehicle's oil reservoir and into an oil drain pan, where it can then be transported and properly disposed of in approved containers.

Typically, an oil drain pan has a capacity to hold between 5-10 quarts of oil, as that is the typical amount of oil used by most consumer vehicles. Additionally, the typical oil drain pan includes a spout or pouring surface to facilitate the transfer of oil from the drain pan to the approved disposal container; however, these spouts do not regulate the flow rate of the oil and often result in unintentional spills when transferring used oil out of the drain pan. These spills can present a slip and fall risk for those working on or around the vehicle and may further present an environmental hazard if not cleaned up properly. Even in best case scenarios, oil spills cause lost work time as work needs to stop while the spill is addressed and cleaned up.

Some current oil drain pans further include a device or area designed to hold a used oil filter that has been removed from the vehicle. These filter holders are intended to allow the oil filter to drain into the drain pan; however, like the spouts, these filter holders often do not allow proper flow of oil from the filter to the drain pain, and therefore commonly cause spills. Further, these filter holders often do not permit the oil to drain completely from the filter, causing additional difficulty when removing the filter from the holder. For example, oil filter holders of current drain pans often allow oil to start to drain from the filter when the filter is first places on the holder, but as the filter sits, the design of the holder tends to block the opening and no more oil can drain from the filter. Thus, when the filter is removed, the flow of oil restarts, causing spillage and or increasing the time needed to fully drain the filter before disposal. Often, the final draining of the oil filter must be done manually, further reducing the speed and availability of the technician performing the oil change.

### SUMMARY OF THE INVENTION

The present disclosure addresses these and other issues by providing an oil drain pan with an improved pour spout that allows for proper transfer of liquid from the drain pan into other containers. The provided oil drain pan further provides an improved oil filter holder that allows complete drainage of oil from an oil filter with reduced or eliminated spillage and with reduced or eliminated manual intervention to allow complete drainage of the filter.

In one aspect, an exemplary embodiment of the present disclosure may provide a drain pan comprising: an exterior wall surrounding a base and defining a fluid reservoir therein, the exterior wall having a top edge around the circumference thereof; a spout defined in the exterior wall and angled downwardly from a plane defined by the top edge of the exterior wall, the spout further defining a spout opening; and a base of the spout positioned below a midline of the exterior wall.

In another aspect, an exemplary embodiment of the present disclosure may provide a drain pan comprising: an exterior wall surrounding a base and defining a fluid reservoir therein, the exterior wall having a top edge around the circumference thereof; a spout defined in the exterior wall and angled downwardly from a plane defined by the top edge of the exterior wall, the spout further defining a spout opening; a base of the spout positioned below a midline of the exterior wall; a shelf; and an oil filter support post.

In yet another aspect an exemplary embodiment of the present disclosure may provide a drain pan comprising: an exterior wall surrounding a base and defining a fluid reservoir therein, the exterior wall having a top edge around the circumference thereof; a spout defined in the exterior wall and angled downwardly from a plane defined by the top edge of the exterior wall, the spout further defining a spout opening; a base of the spout positioned below a midline of the exterior wall; a shelf; an oil filter support post; and a ridge defined in the exterior wall and extending into the reservoir operable to direct oil from the reservoir towards the base of the spout

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1A (FIG. 1A) is a top side perspective view of an exemplary oil drain pan according to one aspect of the present disclosure.

FIG. 1B (FIG. 1B) is a side elevation view of an exemplary oil drain pan according to one aspect of the present disclosure.

FIG. 1C (FIG. 1C) is a front elevation view of an exemplary oil drain pan according to one aspect of the present disclosure.

FIG. 1D (FIG. 1D) is a top plan view of an exemplary oil drain pan according to one aspect of the present disclosure.

FIG. 2 (FIG. 2) is a side elevation view of an exemplary oil drain pan and spout according to one aspect of the present disclosure.

FIG. 3A (FIG. 3A) is a top side perspective view of an exemplary oil drain pan according to one aspect of the present disclosure.

FIG. 3B (FIG. 3B) is a top rear perspective view of an exemplary oil drain pan according to one aspect of the present disclosure.

FIG. 4A (FIG. 4A) is a top side perspective view of an exemplary oil drain pan according to one aspect of the present disclosure.

FIG. 4B (FIG. 4B) is a close up detail view of the area highlighted in FIG. 4A of an exemplary oil drain pan according to one aspect of the present disclosure.

Similar numbers refer to similar parts throughout the drawings.

### DETAILED DESCRIPTION

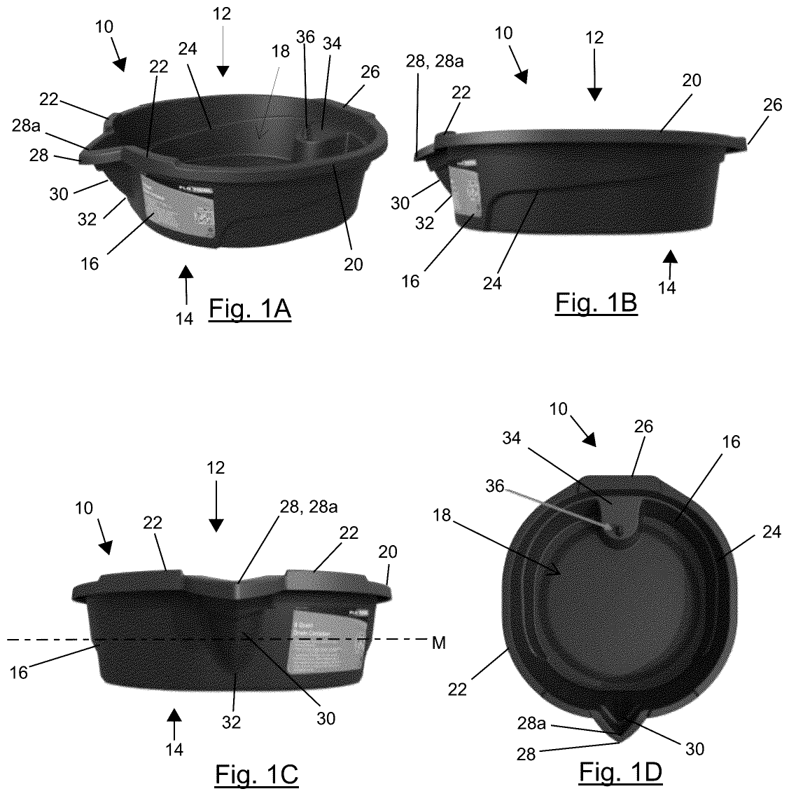

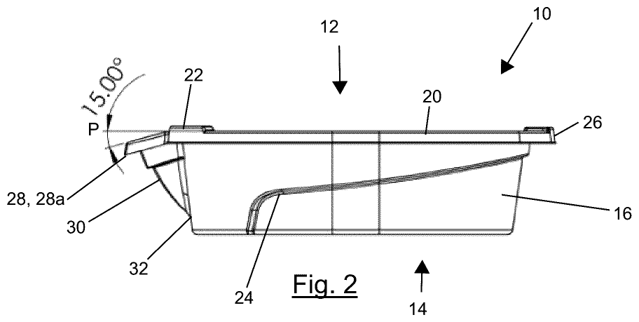

With reference to FIGS. 1A-2, an exemplary oil drain pan is shown and indicated as drain pan 10, or simply pan 10. Drain pan 10 may have a top 12 and a bottom 14 which may defined the vertical direction therebetween. Drain pan 10 may be substantially circular or similarly shaped and may further have a side wall 16 that may define the outer sides of pan 10, and may further define the interior reservoir 18 of pan 10 in which oil may be deposited, as discussed further herein. Accordingly, top 12 of pan 10 may be open while bottom 14 may be closed to further define the reservoir 18, as discussed below.

Drain pan 10 may be formed of any suitable material utilizing any suitable method of manufacture. According to one aspect, drain pan 10 may be formed of plastic or other similar material and may be constructed as a single piece using blow molding, rotational molding, or any other suitable means for construction.

Drain pan 10 may be formed in any suitable size and/or shape as dictated by the desired implementation and use thereof. According to one aspect, pan 10, or more specifically, reservoir 18, may have a fluid capacity of approximately five (5) to ten (10) quarts. According to another aspect, reservoir 18 of drain pan 10 may have a capacity of approximately 8 quarts. Similarly, although shown in a substantially circular configuration, drain pan 10 may be constructed in any suitable shape, including, but not limited to, oval, elliptical, or any other desired shape according to the use and implementation thereof. Accordingly, it will be understood that the configuration shown and described herein is intended as an exemplary configuration and is not to be limited as such.

Drain pan 10 is described herein for use in capturing used motor oil and transferring the oil to a separate container or the like; however, it will be understood that this is an exemplary use and that drain pan 10 may be utilized to capture and transfer any desired fluid or fluid like substance while providing the same benefits as described herein. Thus, references to “oil,” “motor oil,” and “fluids” may be understood to refer to any fluid or liquid used in association with drain pan 10.

Side wall 16 may have a top edge 20 which may be rolled or otherwise folded to provide a lip or flange which may be useful in carrying and/or handling the drain pan 10 when in use. Top edge 20 may further define a horizontal plane P (as best seen in FIG. 2). Top edge 20 of side wall 16 may further include one or more barrier extensions 22 (also referred to herein as barrier(s) 22) which may be adjacent to a pour spout 28 (discussed below) to help prevent oil spills when transferring oil from drain pan 10 to a disposal container, as discussed below. According to one aspect, barriers 22 may be integrally formed with the top edge 20 and may extend slightly above horizontal plane P in the areas to either side of spout 28, as best seen in FIG. 1C.

Side wall 16 may further define a ridge 24 that may extend into the reservoir 18 around a majority of the drain pan 10. Ridge 24 may be slanted such that it is closer to the top edge 20 of side wall 16 opposite the spout 28 and closer to the bottom 14 of drain pan 10 as it approaches the spout 28. This ridge 24 may help direct the flow of oil towards the spout 28 as described further herein.

Top edge 20 may further define a handle 26 or similar structure opposite the spout 28 to facilitate the use and handling of drain pan 10, particularly when reservoir 18 is filled with oil. Handle 26 may be integrally formed with top edge 20 and may be any suitable size, shape, and/or configuration as dictated by the desired implementation.

As mentioned above, drain pan 10 may include a spout 28 which may be defined or otherwise formed in the side wall 16 of drain pan 10. Spout 28 may have a spout opening 28a which may be the point of the spout 28 where it is intended for oil to pour out of reservoir 18 when the oil pan is tipped, as discussed below. Spout opening 28a may be pointed or angled to form a substantially triangular shape, as best seen in FIG. 1D. This may further facilitate the pouring of oil from the reservoir 18 to another container.

Spout 28 may further include a neck portion 30 and a base 32. Neck portion 30 may extend outwardly from the side wall 16 and may be in fluid communication with the reservoir 18 to allow oil to move through the neck 30 and towards the spout opening 28a. Base 32 may be the bottom most portion of spout 28 and may be defined as the point where the spout 28 and neck 30 begin to extend from the side wall 16.

As best seen in FIG. 1C, base 32 may be located below a midline M of drain pan 10 which may cause oil within reservoir 18 to move into the neck 30 of spout 28 with less turbulence, thus providing for a smoother flow. The position of base 32 below the midline M and closer to the bottom 14 of drain pan 10 may reduce bubbling and “glugging” of the oil as it is poured out of drain pan 10 which may further reduce spills and over pours.

With reference to FIG. 2, top edge 20 of spout 28 may have a slight downward angle relative to plane P. This may position the spout opening 28a below the top edge 20 of the drain pan 10. Accordingly, the location of spout opening 28a may define the upper most limit of the capacity of drain pan 10 and reservoir 18. In other words, if the reservoir 18 is filled above the position of spout opening 28a, oil will begin to spill out of the drain pan 10. In this configuration, this is advantageous as it provides a single spill over point, which may be accounted for when working with volumes of oil that are close to or may slightly exceed the capacity of reservoir 18. Put another way, if the volume of oil exceeds the capacity, it will be known where the spill will occur and precaution may be taken. Contrast this with other existing oil pans where a spill may occur anywhere around the perimeter of the pan.

Similarly, the position of the spout opening 28a below plane P allows for precision and control of the flow of oil when pouring or emptying oil from the reservoir 18. Specifically, the downward angle of spout 28 relative to plane P provides that oil will begin to exit the reservoir 18 via spout opening 28a and not over the top edge 20 of side wall 16. The inclusion of barriers 22 adjacent the spout 28 and spout opening 28a further provide assurance if the operator or user of drain pan 10 begins the pour too aggressively. The barriers 22 may provide additional restraint of the oil, further directing the flow back to spout 28.

According to one aspect, spout 28 may be angled downwards at any suitable angle greater than one (1) degree relative to plane P; however, the greatest benefit may be realized between the angles of one (1) degree to twenty (20) degrees, with the maximum benefit realized at approximately fifteen (15) degrees downward relative to plane P. Other suitable angles between ten (10) and twenty (20) degrees provide similar benefits. While angles greater than twenty (20) degrees may be employed, the steeper the angle, the more likely an accidental spill will occur. Thus, increasing the angle too far may have an opposite effect, making the likelihood of a spill increase.

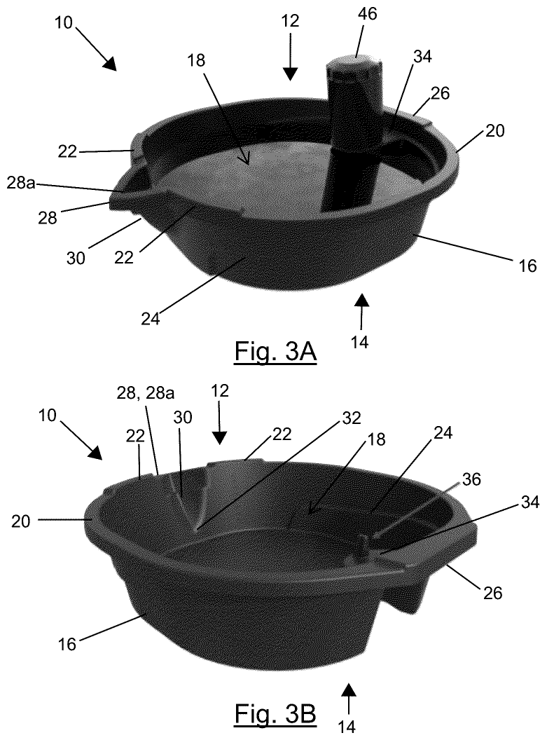

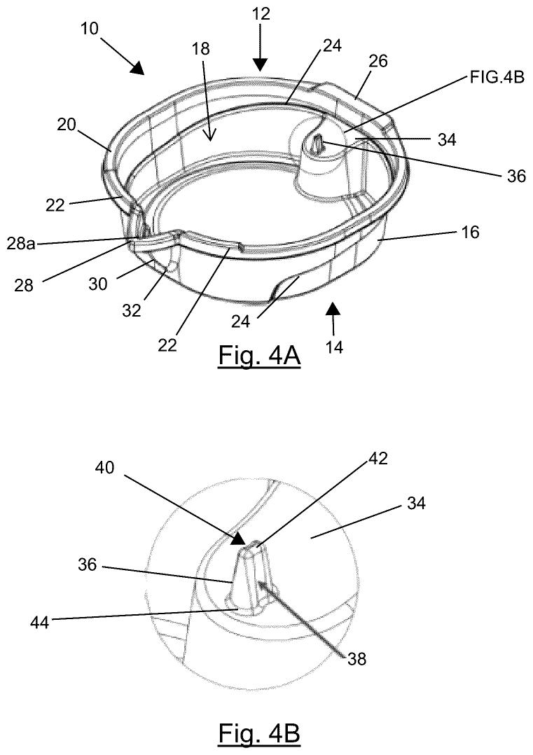

With reference to FIGS. 3A-4B, drain pan 10 may further include a shelf 34 and an oil filter support post 36. As shown in the figures, shelf 34 may extend from the side wall 16 into the reservoir 18 below the top edge 20 of the side wall 16. Filter support post 36 may then extend upwards from shelf 34 at or near an end thereof furthest from the side wall 16. Filter support post 16 may be sized and configured to be inserted into the central opening of an oil filter, such as oil filter 46 shown in FIG. 3A. As discussed below, oil filter 46 may be a used filter removed from a vehicle during an oil change and placed on filter support post 36 and shelf 34 to drain. Shelf 34 may be slanted slightly downward and/or to the side to allow any oil that may spill onto shelf 34 to drain into the reservoir 18. Further, if the fluid level within the reservoir 18 rises above the level of shelf 34, this slanted configuration may further facilitate the flow of fluid off of the shelf 34 when the drain pan 10 is being emptied.

Filter support post 34 may have a first channel 38 defined in a side thereof and a second channel 40 defined in a second side thereof, opposite the first channel 38. Filter support post 34 may have a top 42 vertically spaced apart from a base 44, with the top 42 being narrower than the base 44. This configuration, with top 42 narrower than base 44, and with first and second channels 38 and 40 on the sides, may give the filter support post 34 a generally pyramidal hourglass shape, which may allow space for oil to drain from the oil filter 46 while maintaining sufficient structural support to hold the oil filter upright and in place. Contrast this with existing oil pans having a filter support, which typically use a cylindrical shape that fully plugs the opening in the oil filter, and the advantage is shown that the pyramidal hourglass shape of filter support post 36 is more suitable for draining the oil filter 46 with greater efficiency and without the need for additional manual intervention.

Having thus described the elements and components of drain pan 10, the operation and use thereof will now be described.

As mentioned above, the use of drain pan 10 is being described in relation to draining used motor oil out of an associated vehicle, but it will be understood that drain pan 10 may be used for any suitable fluid catching, carrying, and/or transfer/disposal. According to one non-limiting but related example, drain pan 10 may be used to drain other vehicle fluids, such as coolant, transmission fluid, or the like.

Thus, in an example operation vehicle oil change, drain pan 10 may be placed under the vehicle's oil drain plug. When the plug is removed, the oil may drain from the vehicle and into the reservoir 18 of drain pan 10. While the oil drains from the vehicle, the technician performing the oil change may remove the used oil filter 46 from the vehicle and place it on the filter support post 36. The technician may then wait as the oil is drained from both the vehicle and filter and may perform other activities in this time. For example, checking other vehicle systems, filling other fluids, or the like.

Once the oil has drained from the vehicle, the drain plug may be replaced, and the technician may move drain pan 10 from under the vehicle's oil pan and may carry the drain pan 10 to a proper oil disposal receptacle. Here, the technician may tip the drain pan 10 to start pouring oil out of spout 28 and into the disposal receptacle. As discussed above, the downward angle of the spout 28 may provide less turbulent fluid transfer and may allow the technician more control of the fluid flow. This, in turn, may provide that there is less spillage and less potential hazard, while simultaneously providing reduced time as the oil filter 46 is likewise drained in the same process.

Once the reservoir 18 is emptied, the used filter 46 may be discarded, the drain pan 10 may be cleaned and prepared for its next use.

As compared to current oil drain pans, the presently described drain pan 10 may allow the technician to perform oil changes faster and more efficiently, while simultaneously reducing or eliminating hazardous spills.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A drain pan comprising:
an exterior wall surrounding a base and defining a fluid reservoir therein, the exterior wall having a top edge around the circumference thereof;
a spout defined in the exterior wall and angled downwardly from a plane defined by the top edge of the exterior wall, the spout further defining a spout opening; and
a base of the spout positioned below a midline of the exterior wall.

2. The drain pan of claim 1 further comprising:
at least one wall extension defined in the top edge of the exterior wall next to the spout opening.

3. The drain pan of claim 1 further comprising:
a shelf; and
an oil filter support post.

4. The drain pan of claim 3 wherein the oil filter support post further comprises:
a top;
a base;
a first channel extending between the top and the base; and
a second channel extending between the top and the base; wherein the first and second channels are operable to allow oil to flow therethrough when an oil filter is on the oil filter support post.

5. The drain pan of claim 4 wherein the base of the oil filter support post is wider than the top of the oil filter support post.

6. The drain pan of claim 1 wherein the spout is angled downward from the plane defined by the top edge of the exterior wall in a range between one (1) and twenty (20) degrees.

7. The drain pan of claim 6 wherein the spout is angled downward from the plane defined by the top edge of the exterior wall in a range between zero (10) and twenty (20) degrees.

8. The drain pan of claim 7 wherein the spout is angled downward from the plane defined by the top edge of the exterior wall by approximately fifteen (15) degrees.

9. The drain pan of claim 1 further comprising:
a ridge defined in the exterior wall and extending into the reservoir operable to direct oil from the reservoir towards the base of the spout.

10. A drain pan comprising:
an exterior wall surrounding a base and defining a fluid reservoir therein, the exterior wall having a top edge around the circumference thereof;
a spout defined in the exterior wall and angled downwardly from a plane defined by the top edge of the exterior wall, the spout further defining a spout opening;
a base of the spout positioned below a midline of the exterior wall;
a shelf; and
an oil filter support post.

11. The drain pan of claim 10 wherein the oil filter support post further comprises:
a top;
a base;
a first channel extending between the top and the base; and
a second channel extending between the top and the base; wherein the first and second channels are operable to allow oil to flow therethrough when an oil filter is on the oil filter support post.

12. The drain pan of claim 11 wherein the base of the oil filter support post is wider than the top of the oil filter support post.

13. The drain pan of claim 10 wherein the spout is angled downward from the plane defined by the top edge of the exterior wall in a range between one (1) and twenty (20) degrees.

14. The drain pan of claim 13 wherein the spout is angled downward from the plane defined by the top edge of the exterior wall in a range between zero (10) and twenty (20) degrees.

15. The drain pan of claim 14 wherein the spout is angled downward from the plane defined by the top edge of the exterior wall by approximately fifteen (15) degrees.

16. The drain pan of claim 10 further comprising:
a ridge defined in the exterior wall and extending into the reservoir operable to direct oil from the reservoir towards the base of the spout.

17. A drain pan comprising:
an exterior wall surrounding a base and defining a fluid reservoir therein, the exterior wall having a top edge around the circumference thereof;
a spout defined in the exterior wall and angled downwardly from a plane defined by the top edge of the exterior wall, the spout further defining a spout opening;
a base of the spout positioned below a midline of the exterior wall;
a shelf;
an oil filter support post; and
a ridge defined in the exterior wall and extending into the reservoir operable to direct oil from the reservoir towards the base of the spout.

18. The drain pan of claim 17 wherein the spout is angled downward from the plane defined by the top edge of the exterior wall in a range between one (1) and twenty (20) degrees.

19. The drain pan of claim 18 wherein the spout is angled downward from the plane defined by the top edge of the exterior wall in a range between zero (10) and twenty (20) degrees.

20. The drain pan of claim 19 wherein the spout is angled downward from the plane defined by the top edge of the exterior wall by approximately fifteen (15) degrees.
